(19) United States
(12) Patent Application Publication
(10) Pub. No.: US 2008/0139098 A1
(43) Pub. Date: Jun. 12, 2008

(54) Device For Selecting And Counting Coins

(76) Inventor: Graziano Azzurri, Firenze (IT)

Correspondence Address: MCGLEW & TUTTLE, PC, P.O. BOX 9227, SCARBOROUGH STATION, SCARBOROUGH, NY, 10510-9227, US

(21) Appl. No.: 11/813,698

(22) PCT Filed: Jul. 7, 2005
(86) PCT No.: PCT/IT05/00386

§ 371 Date: Jan. 22, 2008

(30) Foreign Application Priority Data
Jan. 12, 2005 (IT) FI2005A000004

(51) Int. Cl. G07D 3/04; G07D 3/12

(52) U.S. Cl. 453/5; 453/3

(57) ABSTRACT

The spontaneous rolling channel (9) is combined with an opposed gauging plate or “gauge” (12) with stepped edge on which the rolling coins rest laterally and roll, to drop selectively into differentiated paths (14A-14D) as a function of the diametric dimensions thereof; the gauge (12) has two opposed stepped edges (12A-12D and 12E-12H) and can be positioned overturned to activate one or other of the stepped edges the number of steps are approximately half the number of the denominations of coins.

Devices for selecting and counting coins are known, provided in a front—greatly inclined with respect to the horizontal—with a hopper to receive coins of various denominations and a pick-up member, generally a rotating disc with recesses, to pick up one coin at a time and to feed it to a selecting unit. The latter has a spontaneous rolling channel in which coins roll through gravity; the coins are guided on a supporting and rolling edge and on a specific gauging plate or “gauge” with stepped edge, on which said coins rest and slide by rolling; the coins drop selectively into differentiated areas as a function of the diametric dimensions thereof, to follow separate paths equipped with counters until reaching corresponding receptacles.

These devices currently comprise the same number of differentiated areas—with relative paths, counters and receptacles—as the number of denominations or sizes of coins to be selected. Consequently, current devices are relatively heavy and cumbersome (as well as costly) and are somewhat unsuitable to be transported to be used in the many facilities in which coins must to be counted rapidly, such as trading concerns or very busy premises, where automatic dispensers are present for the sale of small items (cigarettes, beverages, comfort goods, etc.) purchasable by inserting coins of various denominations; the coins that have accumulated must frequently be collected and counted to establish the total monetary value thereof.

The principal object of the invention is to provide a device which—although capable of counting coins of all denominations—is less cumbersome and less heavy than current devices, and is easy and rapid to use. These and other objects and advantages shall be apparent from the text hereunder.

Substantially, in the device of the invention: the number of said differentiated areas is less than the number of the dimensions, i.e. the denominations or sizes of the coins to be selected; and the gauging plate or gauge is adaptable to different selection needs, and can be engaged by positioning means and by easily neutralizable constraining means to allow the removal and replacement of said gauging plate or gauge, or to allow modification of the position thereof, or can even be equipped with adjustable components, to modify the stepped edge according to the group of denominations of coins to be selected. In this way, it is possible to select coins belonging to groups of coins of a limited number of dimensions or denominations and discard coins belonging to groups of coins of a different limited number of dimensions, to be selected in at least one subsequent operation.

In this way, the weight and overall dimensions of the device are reduced, while rapid selection of coins of a plurality of denominations is still possible in two subsequent operating phases.

In a practical embodiment, the structure of the device is provided with pin registers or templates to guarantee simple unequivocal positioning of a selected gauging plate or gauge.

Two or more gauging plates, positionable alternately in operating positions, could be provided.

In addition or alternatively, a single gauging plate or gauge can have two stepped edges and the plate is in this case susceptible to be positioned in two different positions so that in each position a different stepped edge is made active. In this case, said gauging plate can be applied in two positions rotated through 180° in the plane thereof, or can be applied in two positions obtained by overturning.

The gauging plate or gauge can have centering pins to be housed in respective seats, and gripping handles for the handling thereof. The plate can be constrained by means of a hole for the threaded shank of a fixing knob screwable onto the front of the device.

With the aforesaid solution it is possible to operate in two subsequent phases of selection and counting, and an area is provided for excluding all coins with dimensions smaller than all those selectable, to allow implementation of a subsequent operation to select or count the previously excluded coins.

The invention shall be better understood by following the description and accompanying drawing, which shows a practical non-limiting embodiment of said invention. In the drawing:

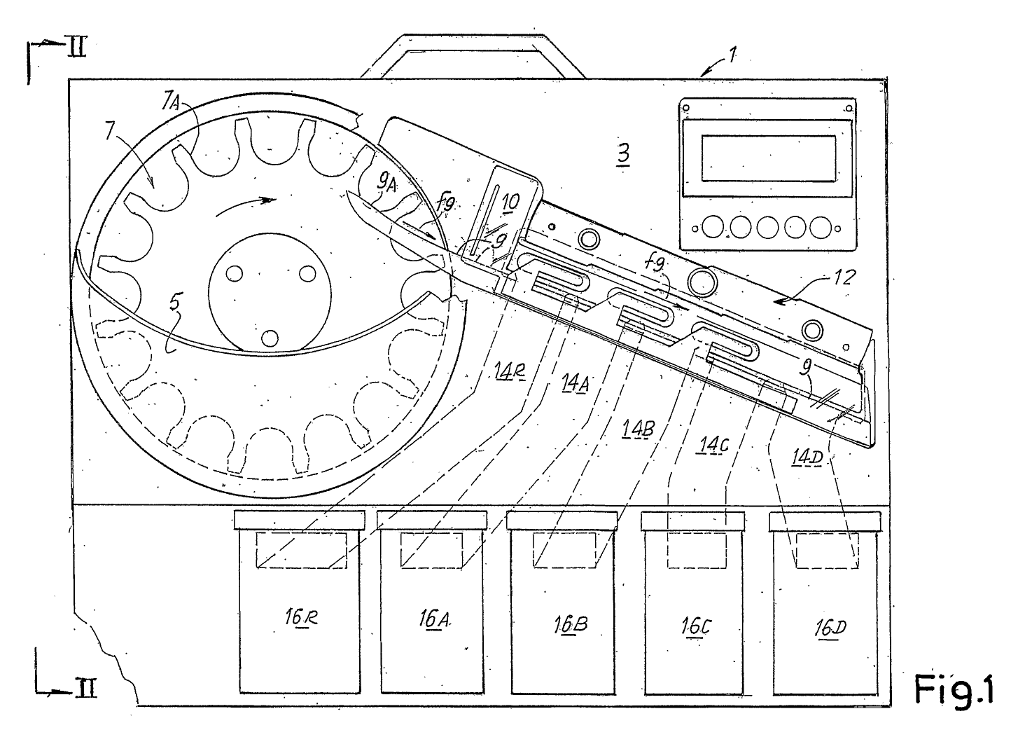

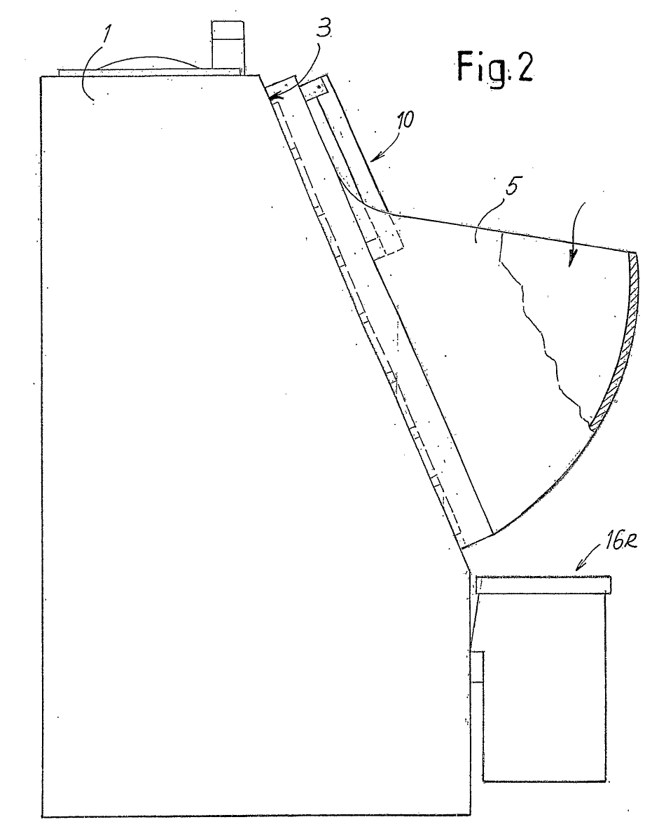

FIGS. 1 and 2 schematically show the machine as a whole in a front view and in a side view according to II-II;

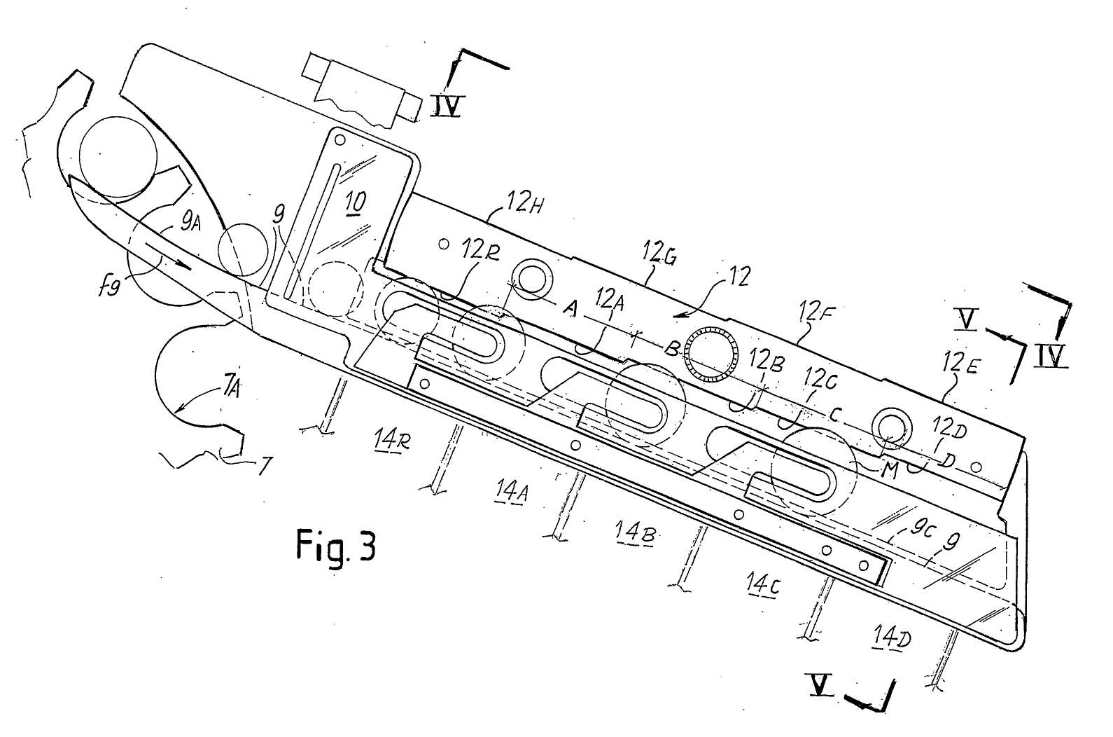

FIG. 3 shows in greater detail the selecting unit in a front view;

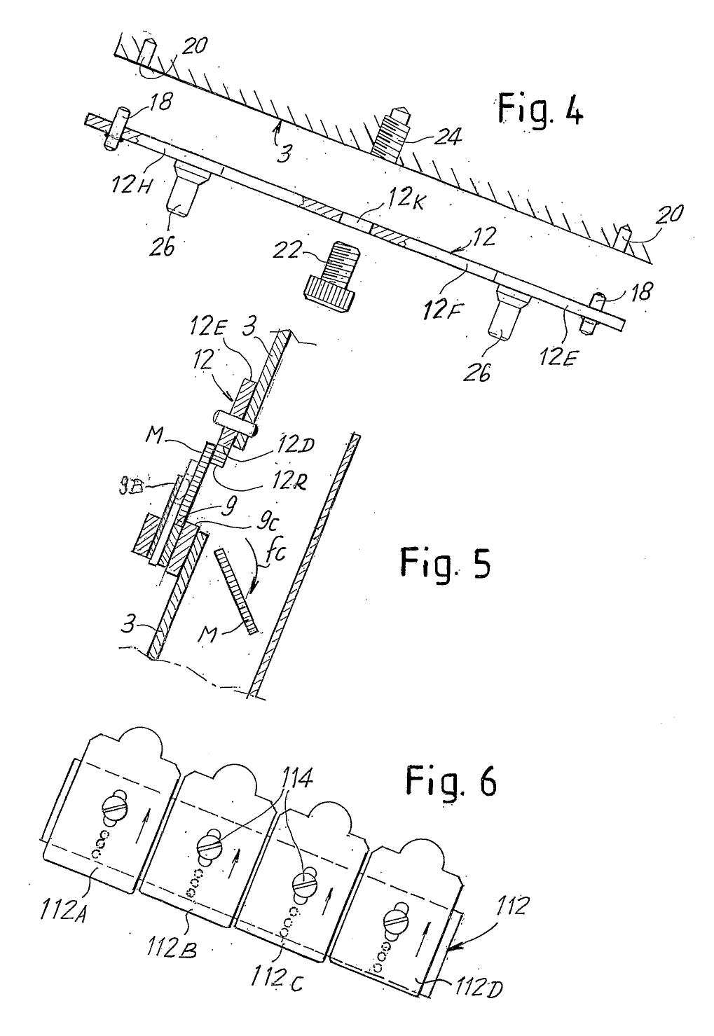

FIGS. 4 and 5 show a view of the line IV-IV in FIG. 3 with separate parts, and a local cross section according to V-V in FIG. 3; and

FIG. 6 shows a possible variant of embodiment.

According to the illustration in the accompanying drawing, the case of the device forming the object of the invention is indicated with 1, said case having an inclined front 3, on which the assemblies for selection are developed.

Applied to said front 3 is a hopper 5 suitable to receive the coins for selection; at the level of this hopper 5 the front has a rotating disc pick-up member 7, in which peripheral recesses 7A are produced, destined to receive each coin during transit by rotation of the disc 7 in the area containing the coins collected in the hopper 5. Provided adjacent to said hopper 5 and to the pick-up disc 7 of the coins is a spontaneous rolling channel, indicated generically with 9, which is inclined downwards starting from the assembly 5-7, starting from an intermediate area of the development of the disc 7; therefore, the coins conveyed in the recesses 7A can slide in said channel 9 and roll according to the arrow f9 along said channel, where the coins must be selected by dropping. From the initial area 9A of the channel 9, the coins rolling according to the arrow f9 encounter control, selection and counting means of a type per se known, in a position generically indicated with 10; the coins then continue along the channel 9. Inferiorly, the channel 9 (see in particular FIG. 5) has a resting and rolling edge between an outer side 9B and a relatively very limited inner side 9C, while superiorly the rolling channel is delimited by a gauging plate or “gauge” generically indicated with 12, which is applied to the front 3; the coins rest on said plate 12 until they reach a respective dropping area according to f_{c}, to which stepped sections of the inferior edge of the plate 12 correspond.

In conventional solutions of devices of this type, the channel 9 and therefore also the gauging plate or gauge 12 are developed for a considerable length to obtain a plurality of subsequent and different stepped dropping areas of the gauge 12 which operates as “go/no-go”; in conventional solutions these areas are of the same number as the totality of denominations, i.e. diametric dimensions of the coins to be selected; a section of rolling path corresponding to one of the successive steps of the inferior edge of the gauge corresponds to each of said areas. In conventional devices the channel 9 is of a considerable length and the differentiated areas as a function of the diametric dimensions are many, generally corresponding to the number of dimensions or denominations of the coins to be selected. A dropping path indicated with dashed lines, respectively 14A, 14B, 14C, 14D . . . , corresponds to each of the differentiated areas A, B, C, D . . . shown in the drawing, and reaches a respective receptacle 16A, 16B, 16C, 16D . . . , where the coins of each denomination, selected along the channel 9 with the “go/no-go” system, can be collected. In fact, coins like the one indicated with M in FIG. 5 along the rolling path in the channel 9 rest on the gauge 12, which is provided with a stepped inferior edge 12A, 12B, 12C, 12D . . . to which the paths 14A, 14B, 14C, 14D . . . and respective receptacles 16A, 16B, 16C, 16D . . . correspond. In this way coins of a plurality of denominations with progressively larger dimensions are selected, and drop at the level of the steps 12A, 12B, 12C, 12D . . . to reach the paths 14A, 14B, 14C, 14D . . . and the respective receptacles 16A, 16B, 16C, 16D . . . . In conventional machines the denominations selected are equal to the denominations of the coins in circulation, e.g. eight denominations or whatever the number might be, and there are the same number of steps 12N, paths 14N and receptacles 16N.

According to the invention, however, a lesser number of steps are provided, for example four steps 12A, 12B, 12C, 12D with respective paths and receptacles; furthermore, an area 12R, with a corresponding path 14R, is provided for all coins having dimensions smaller than those that drop at the level of the first step 12A; the coins that follow the path 14R are collected in a receptacle 16R mixed with one another.

Characteristically, according to the present invention and according to the example, a gauging plate or gauge 12 is provided which is susceptible to be movable and applicable in two different positions. In particular, the gauging plate or gauge 12 has, besides the stepped edge 12A, 12B, 12C, 12D, also a second and opposed stepped edge 12E, 12F, 12G, 12H and this plate or gauge 12 is mounted on the front 3 of the case in two possible opposed positions by overturning.

To apply the plate 12 to the plate 12 two pins 18 are provided, distanced from each other and susceptible to be housed with precision in seats 20 produced in the front 3, while a fixing system is provided with a knob fixing member 22 with a threaded shank, which can pass through a hole 12K of the gauging plate 12 to be engaged in a threaded hole 24 of the front 3 of the device; the gauging plate or gauge 12 can be provided with gripping means, such as handles 26, to allow the user to easily remove the plate 12 from a first position and rotate it in the plane thereof to place in the operating position first the stepped edges 12A to 12D and subsequently the stepped edges 12E to 12H, inserting the plate each time with the guide pins 18 in the seats 20 and fixing it with the knob 22 screwed into the hole 24.

With this arrangement, firstly coins of the four largest denominations are selected and collected in the receptacles 16A, 16B, 16C and 16D, while all the coins with smaller denominations are collected in the receptacle 16R. Subsequently, the coins collected in the receptacle 16R are discharged into the hopper 5, the gauging plate or gauge 12 is overturned into the second position and all the coins which during the first phase of the cycle were collected and discarded all together into the receptacle 16R are now selected.

It is evident that in this way the horizontal length and also the weight of the device can be reduced as the receptacles and counting systems, together with the paths between the channel 9 and the receptacles 16 are almost halved in number. The counting system must also be changed each time, to also obtain the final count of the coins totally divided into groups.

The receptacles from 16A to 16D can also be provided with application systems to collect coins of a respective denomination in small cylindrical containers used to contain a fixed number of coins, said containers being replaced as they are filled and by stopping selection when the machine indicates they are full, in order to prepare a plurality of containers with the same number of coins of the same denomination.

The arrangement can be modified in the sense that—by choosing gripping systems differing from those 26—a plate can be overturned instead of rotated in the plane thereof to alternately present one or other of the stepped edges with which said plate is equipped. Moreover, rather than one plate with two opposed stepped edges, as indicated in the drawing, it would also be possible to provide two different gauging plates, to be replaced to implement the two (or more) subsequent coin selection phases. An element with three (or more) stepped edges and which can be engaged in the same number of operating positions could also be provided.

According to a further variant schematized in FIG. 6, a gauge 112 can comprise a plurality (for example, four) of slider components 112A, 112B, 112C, 112D, each sliding according to the arrow separately from one another, and which can be positioned in two or more positions by means of cooperating recesses and raised parts, and then fixable with pressure screw means 114 or the like, to modify at will the stepped edge formed by the end edges of said sliders.

It is understood that the drawing only shows an example provided purely as a practical embodiment of the invention, and that said invention can vary in forms and arrangements without however departing from the scope of the concept on which the invention is based. Any reference numbers in the appended claims are provided to facilitate the reading thereof with reference to the description and accompanying drawing, and do not limit the scope of protection represented by the claims.

1. A device for selecting and counting coins, comprising on a front, greatly inclined with respect to the horizontal: a hopper to receive coins of various denominations; a rotating disc pick-up member with recesses or another equivalent means to pick up one coin at a time and feed it to a selecting unit; a spontaneous rolling channel in which coins roll through gravity, guided on a supporting and rolling edge and on an opposed gauging plate or “gauge” with stepped edge, on which the rolling coins rest and slide, to drop selectively at the level of differentiated areas as a function of the diametric dimensions of said coins, to make the coins follow separate paths equipped with counters until reaching corresponding receptacles, wherein the number of said differentiated areas is less than the number of dimensions (denominations) of the coins to be selected, and wherein said gauging plate or gauge is engaged by positioning means and by easily neutralizable constraining means to allow modification of the position thereof, to select coins belonging to groups of coins of a limited number of dimensions and discard coins belonging to groups of coins of a different limited number of smaller dimensions, to be selected in at least one subsequent operation; wherein said gauging plate has at least two stepped edges and can be positioned in a number of operating positions corresponding to the number of stepped edges to make a different stepped edge active in each position.

2. Device as claimed in claim 1, further comprising pin registers or templates to guarantee unequivocal positioning of a selected gauging plate.

3. Device as claimed in claim 1, further comprising more than one gauging plate positionable alternately in the operating position.

4. Device as claimed in claim 1, wherein said plate can be applied in two positions rotated through 180° in the plane thereof.

5. Device as claimed in claim 1, wherein said plate can be applied in two positions obtained by overturning.

6. Device as claimed in claim 5, wherein said plate has centering pins to be housed in seats produced in the front of the device, gripping handles for handling, and fixing means, such as a hole for threading of a knob.

7. Device as claimed in claim 1, further comprising an area, a path, and a receptacle to collect discarded coins of smaller denominations or dimensions to all those selectable, in order to implement a subsequent operation to select and count previously discarded coins, subsequent to providing a gauge suitable for this purpose.

8. A device for selecting and counting coins, comprising on a front, greatly inclined with respect to the horizontal: a hopper to receive coins of various denominations; a means to pick up one coin at a time and feed it to a selecting unit; a channel in which coins roll through gravity, guided on a supporting and rolling edge and on an opposed gauging plate or “gauge” with stepped edge, to drop selectively at the level of differentiated areas as a function of the diametric dimensions of said coins, wherein the number of said differentiated areas is less than the number of the dimensions of the coins to be selected, and wherein means are provided to modify said gauging plate or gauge, to select in different steps coins belonging to different groups of dimensions; wherein said gauging plate has at least two stepped edges and can be positioned in the same number of operating positions to make a different stepped edge active in each position.

9. Device as claimed in claim 2, further comprising more than one gauging plate positionable alternately in the operating position.
